(19) United States
(12) Patent Application Publication
(10) Pub. No.: US 2008/0042427 A1
(43) Pub. Date: Feb. 21, 2008

(54) Security Article with Multicoloured Image

(76) Inventor: Sani Muke, Victoria (AU)

Correspondence Address: GREER, BURNS & CRAIN, 300 S WACKER DR, 25TH FLOOR, CHICAGO, IL, 60606, US

(21) Appl. No.: 10/583,072

(22) PCT Filed: Dec. 15, 2004
(86) PCT No.: PCT/AU04/01757

§ 371 Date: Mar. 6, 2007

(30) Foreign Application Priority Data
Dec. 16, 2003 (AU) 2003906969

(51) Int. Cl. B42D 15/10; B32B 23/08

(52) U.S. Cl. 283/112; 283/77; 283/94; 428/514

(57) ABSTRACT

A security article is provided having a multicoloured image and which comprises a first layer of transparent polymeric material carrying parts of an image formed in a first colour; and at least one other layer of transparent polymeric material carrying parts of the image formed in a different colour. The layers are laminated together with the parts of the image formed in the first and different colours superposed over one another, whereby the colours combine to form a multicoloured image in the laminated security article. In one embodiment, the multi coloured image is viewable from both sides of the security article, and in another form an opaque layer may be provided on one side of the transparent layers to provide a background for viewing the image in reflection from one side of the article.

This invention relates to security articles having multicoloured images, and is particularly but not exclusively, concerned with security articles such as passports, driver licences, identity cards and other security documents. It also relates to methods of manufacturing security articles with multicoloured images.

It is known to provide security documents, such as banknotes, cheques, certificates or the like, with a wide variety of security devices which provide verification of authenticity and protection against copying and counterfeiting. In the case of passports, identity cards and the like, particularly in view of requirements for increasing levels of security, it is important to provide a security article including personalised information, such as a multicoloured photograph of the bearer, which is protected from fraudulent alteration, eg by removal of the photograph and insertion of a replacement photograph.

It is therefore desirable to provide a tamper proof or tamper evident security article having a multicoloured image.

It is also desirable to provide effective methods for manufacturing such security articles with multicoloured images.

According to a first aspect of the invention there is provided a security article having a multicoloured image and which comprises:

a first layer of transparent polymeric material carrying parts of an image formed in a first colour;

at least one other layer of transparent polymeric material carrying parts of said image formed in at least one different colour;

wherein the layers are laminated together with the parts of the image formed in the first and different colours superposed one over another, whereby the colours combine to form a multicoloured image in the laminated security article, the multicoloured image being viewable from both sides of the security article.

According to a second aspect of the invention there is provided a method of manufacturing a security article having a multicoloured image, wherein the method comprises:

providing a first layer of transparent polymeric material;

providing at least one other layer of transparent polymeric material;

forming parts of an image in a first colour in or on the first layer;

forming parts of said image in at least one different colour in or on said at least one other layer; and

laminating the layers together to form a laminated security article;

wherein, in the laminated security article the parts of the image formed in the first and different colours are superposed one over another whereby the colours combine to form a multicoloured image which is viewable from both sides of the laminated security article.

It is possible to form a multicoloured image from two superposed colours, and in this case the step of laminating the layers of transparent polymeric material together may be performed either before or after the parts of the image are formed in the different colours in the respective layers. Preferably, however, the laminated security article has a third layer of transparent polymeric material carrying parts of said image formed in a third, different colour. For example, the first layer may carry said image formed in a red or magenta, the second layer may carry said image formed in green or yellow and the third layer may carry said image formed in blue or cyan. Preferably the colours of the image formed in the different layers are primary or complementary colours.

The laminated security article may include a further layer of transparent polymeric material carrying parts of said image formed in a dark colour eg black. The dark parts of the image provide more depth and definition to the multicoloured image.

Preferably, a laser marking process is used to apply the image formed in the different colours to the different layers. In the laser marking process, a coloured image which is required to be formed in the laminated security article can be scanned by appropriate software into a digital image and separated into individual primary or complementary colours. The laser marking process is used to apply to the parts of the image formed in the first colour to the first transparent layer, then the laser marking process is used to apply the parts of the image formed in the second colour to the second transparent layer. The laser marking process can also be used to apply the parts of the image formed in other different colours to the third and any subsequent layers.

There are various types of laser marking processes which could be used in the present invention. For instance, a laser printing process could be used to print the parts of the image in its respective colours on each layer of transparent polymeric material.

In another form of laser marking process, patches of different coloured pigments may be printed onto the layers of transparent polymeric material and negative parts of the image ablated using laser radiation so that positive parts of the image in the different colours remain on the different layers to form the multicoloured image when the layers are superimposed and laminated together. Such a laminated security article could contain security dyes or destructive layers to indicate tampering with heat or chemicals or other attempts to delaminate the security article.

It is, however, preferred that a laser marking process used which forms the parts of the image in the different colours indelibly in the different layers. Thus, any tampering of the security article by delamination and an attempted altering of the parts of the image formed in the different colours will be evident.

Preferably, a process is used which forms the different parts of the image in different colours embedded within the respective layers of transparent polymeric material.

According to a third aspect of the invention there is provided a tamper evident security article having a multicoloured image and which comprises:

a first layer of transparent polymeric material containing parts of an image formed in a first colour embedded within said first layer;

at least one other layer of transparent polymeric material containing parts of said image formed in at least one different colour embedded within said at least one other layer;

wherein the layers are laminated together with the parts of the image formed in the first and different colours superposed one over another, whereby the colours combine to form a multicoloured image in the laminated security article.

One or more of the layers may comprise a single transparent polymeric film or substrate in which the respective parts of the image are embedded. Alternatively, one or more of the layers may comprise a transparent polymeric substrate having a transparent polymeric film or coating on at least one surface to which the respective parts of the image in colour are embedded.

The parts of the image formed in different colours in the respective layers may be embedded within the layers by using layers of transparent polymeric material each containing a respective latent colour forming pigment. When such a polymeric material is exposed to laser radiation of a particular wavelength, a colour marking is formed within polymeric material by a photochemical reaction between the latent pigment, the polymer and the laser energy.

According to a fourth aspect of the invention, there is provided a method of manufacturing a tamper evident security article having a multicoloured image, wherein the method comprises:

providing a first layer of transparent polymeric material containing a first latent colour forming material;

providing at least one other layer of transparent polymeric material containing a different colour forming material;

forming parts of an image in a first colour by exposing the at least one other layer to laser radiation to develop the latent colour forming material in the first layer;

forming parts of the image in a different colour by exposing said at least one other layer to laser radiation to develop the different latent colour forming material in said at least one other layer; and

laminating the layers together with the parts of the image formed in the first and different colours superposed one over another, whereby the colours combine to form the multicoloured image in the laminated security document.

The polymeric material or materials for the layers containing the latent colour forming materials are conveniently chosen such that the laser only causes colour marking by development of the latent colour marking materials without causing melting or abrasion of the polymeric material or materials. Typical polymers which are not sensitive to laser radiation in the infra red (IR) and ultraviolet (UV) regions include polypropylene, polyethylene (low density, high density or linear low density), and blends of these polymers. Typical thicknesses of such polymers suitable for the present invention fall substantially within the range from about 20 microns to about 200 microns. A thin layer of a low melting point polymer may be co-extruded onto one or both sides of a polymer base film to form at least one of the layers in which a colour forming material is provided. The colour forming material may be provided either in the polymer base film or in the co-extruded layer. The thin co-extruded layer typically would have a thickness falling substantially within the range from about 2 microns to about 50 microns. Suitable materials for the co-extruded layer include: metallocene polyethylene, and random co-polymers or ter-polymer of ethylene, butylene or propylene.

The latent colour forming pigments are preferably present in the layers of transparent polymeric material in a concentration which is sufficiently low so as not to affect the clarity of the transparent polymeric material. Preferably, the concentration of colour forming pigment in the transparent polymeric material falls substantially within the range from about 0.2 to about 0.5% by weight of the polymeric material.

The layers of polymeric material containing the latent colour forming pigments may be produced by premixing a batch of polymer which is blended with the appropriate latent colour forming pigment. One example of a colour forming pigment suitable for use in the present invention is a pigment manufactured by CIBA SC Holding A G which can develop a colour when irradiated with a laser emitting UV light. Such a colour forming pigment may include a latent acid, a colour former and optionally further ingredients as described WO 02/101462. Other examples of suitable colour forming pigments include the IRIODIN LS (laser sensitive) range of pigments (IRIODIN is a Registered Trade Mark of Merck KGaA). The principle of colour formation with Merck IRIODIN LS pigments is based on a carbonisation and surface forming between TiO2 coated mica pigments, the polymer and the laser energy. Typically such pigments develop colour when irradiated with a laser emitting IR radiation.

There are a number of different laser marking processes which may be used in the present invention, including: a beam deflection technique (a vector process); mask techniques; and dot matrix techniques. For variable data, required for personalisation, the beam deflection techniques and dot matrix techniques are most suitable.

A tamper evident security article having a multicoloured image in accordance with the invention is particularly suitable for use in security documents which contain personal information, such as a passport, driver licence, credit card or identity card containing a photograph of the bearer. It will, however, be appreciated that a security article in accordance with the invention may be applied, attached to, contained or incorporated within, other types of documents and articles, such as banknotes, cheques, certificates, entrance tickets and other tokens and articles requiring a tamper evident multicoloured image for authentication and/or protection against copying or theft.

In the case of a passport, a security article according to the first or third aspect of the invention could be secured to or form part of a page of the passport after lamination with the multicoloured image comprising a photograph of the passport bearer.

Alternatively, two or more of the layers of transparent polymeric material could be stitched or otherwise incorporated into a passport booklet before personalisation by formation of the parts of the image in different colours in or on the transparent layers, with the transport layers being subsequently laminated together.

In a particularly preferred embodiment, the layers of transparent polymeric material carrying the parts of the image in different colours are laminated together by providing a lamination coating between at least two adjacent layers of transparent polymeric material. Alternatively, and/or additionally, heat and/or pressure is used to laminate the layers of transparent polymeric material together.

In a booklet such as a passport, at least one adjacent opaque (eg white) page next to a page formed by the laminated security article may assist in enhancing the appearance of the multicoloured image. As the multicoloured image of a security article in accordance with the first aspect of the invention is visible from both sides, preferably opaque pages are provided on both sides of the security article when it forms a page of a booklet, such as a passport.

A tamper evident security article in accordance with the third aspect of the invention is not necessarily visible from both sides and may include an opaque layer on one side of the transparent layers containing parts of the image in different colours, so that the multicoloured image in the laminated security article is only visible in reflection from one side of the article.

A laminated security article in accordance with the invention may include additional security features to enhance its security against tampering and/or copying. For example, the layers containing parts of the image formed in different colours may include printed information and/or other security features, printed or otherwise. The printed information or other security features could be added to one or more of the transparent polymeric layers prior to lamination. The laminated article may be arranged such that a layer provided with the printed information or other security features cohesively ruptures, but with the parts of the image formed in different colours remaining intact. The additional printed security features may include one or more of the following: printed shadow images; images printed with optically variable inks; and/or front to back registration images.

Some preferred embodiments of the present invention will now be described, by way of example only, with reference to the accompanying drawings, in which:

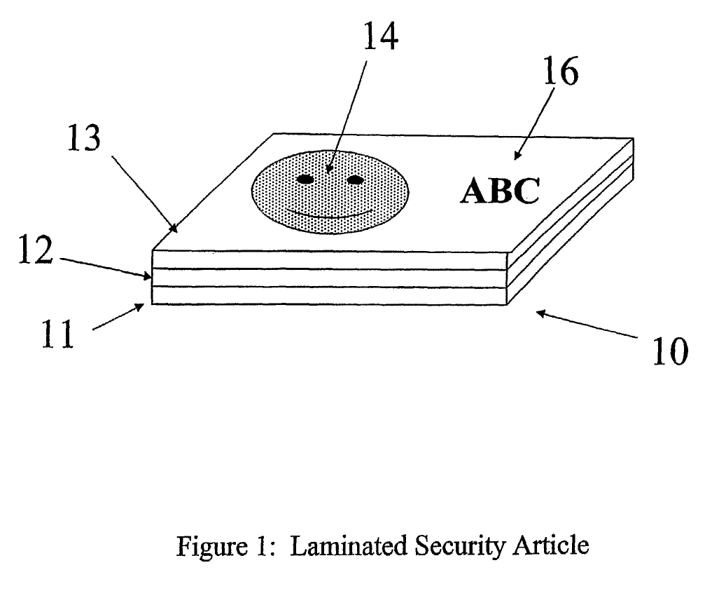

FIG. 1 is a perspective view of a laminated security article in accordance with the invention;

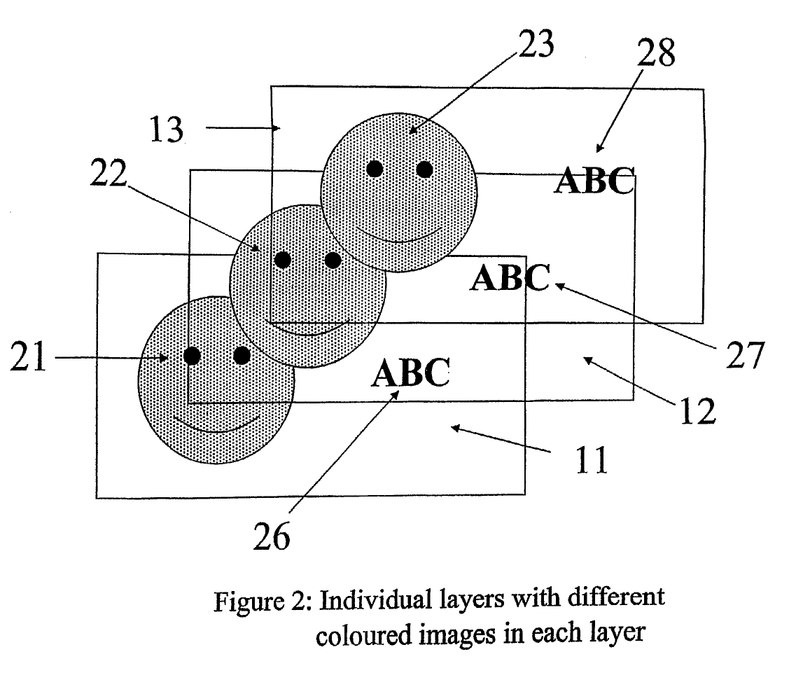

FIG. 2 is a plan view showing individual layers of the security article of FIG. 1;

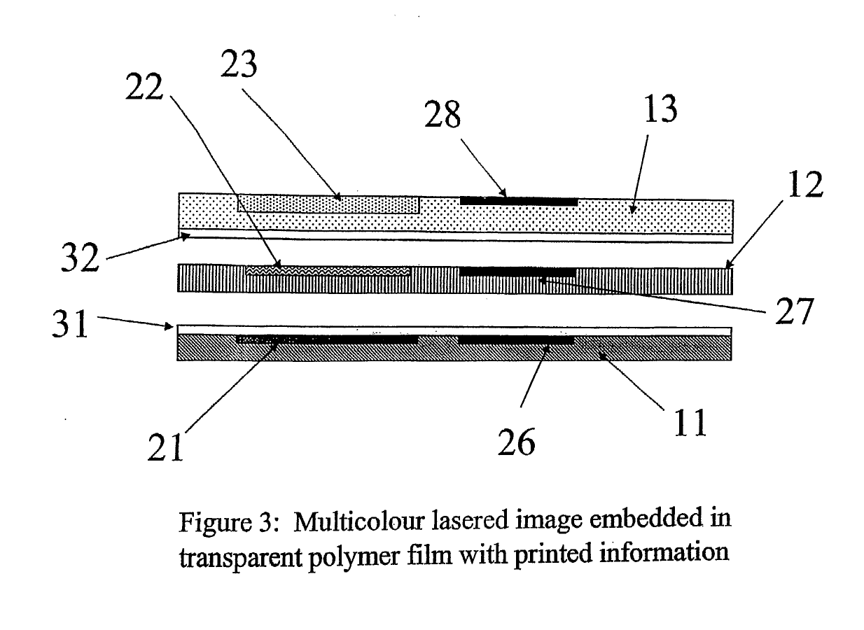

FIG. 3 is a sectional view through layers forming the laminated security article invention;

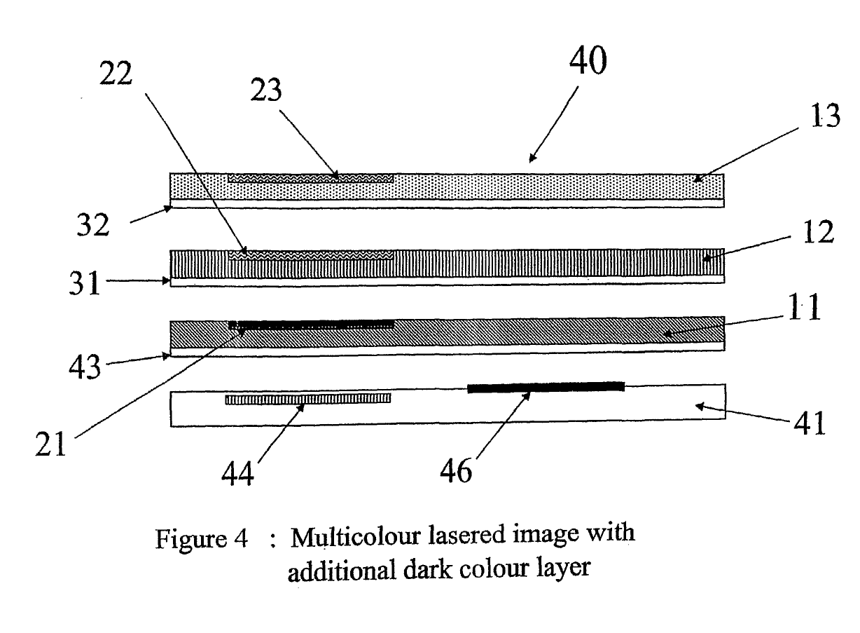

FIG. 4 is a sectional view similar to FIG. 3 of a modified laminated security article;

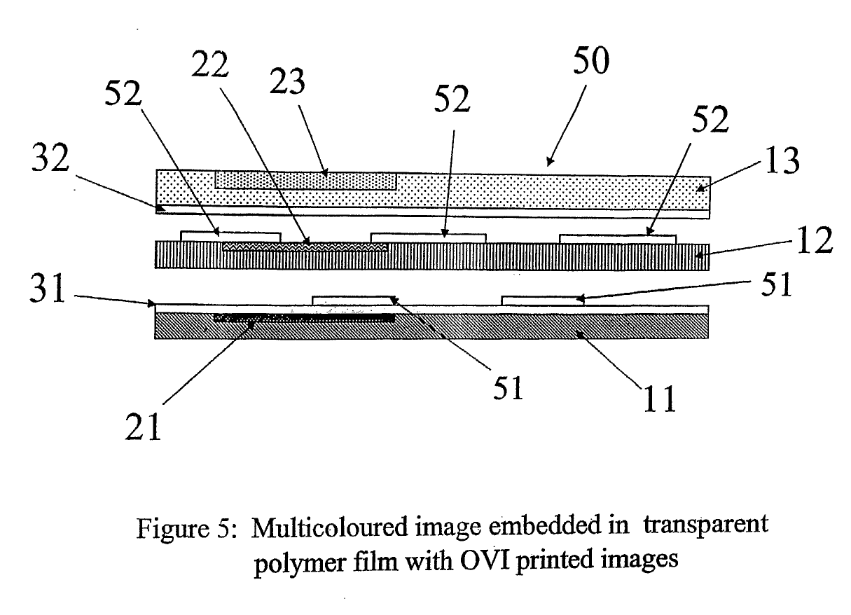

FIG. 5 is a sectional view similar to FIG. 3 of another modified security article;

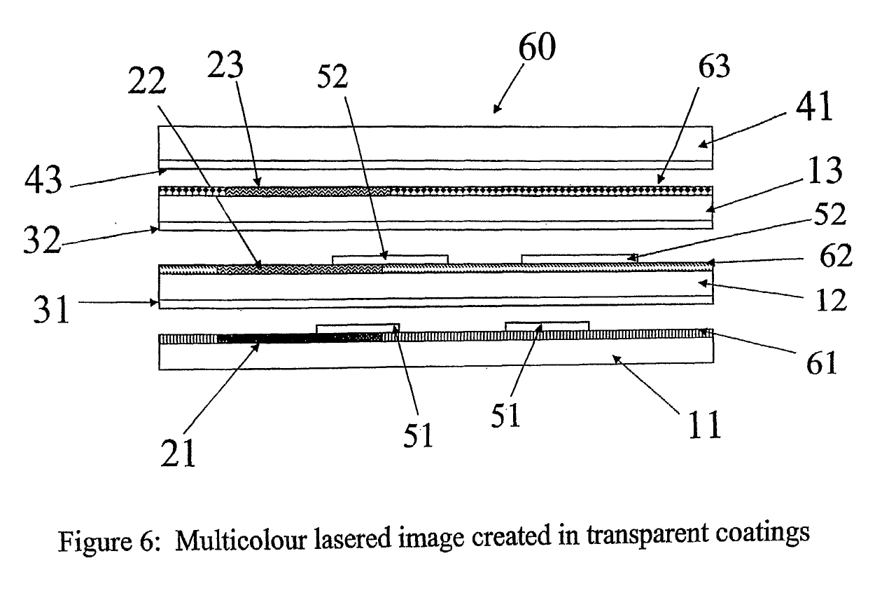

FIG. 6 is a sectional view similar to FIG. 5 of a further modified embodiment;

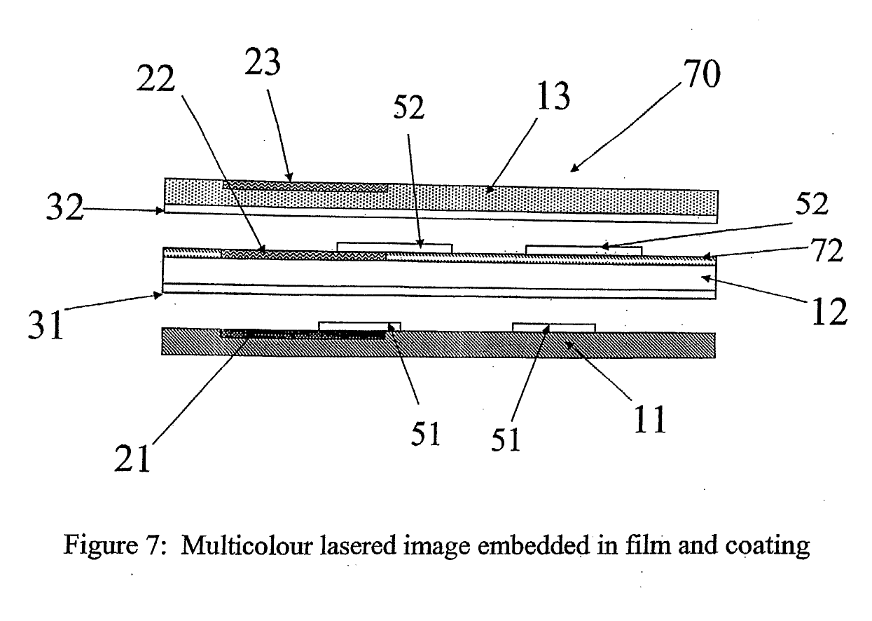

FIG. 7 is a sectional view similar to FIG. 5 of yet another modified embodiment;

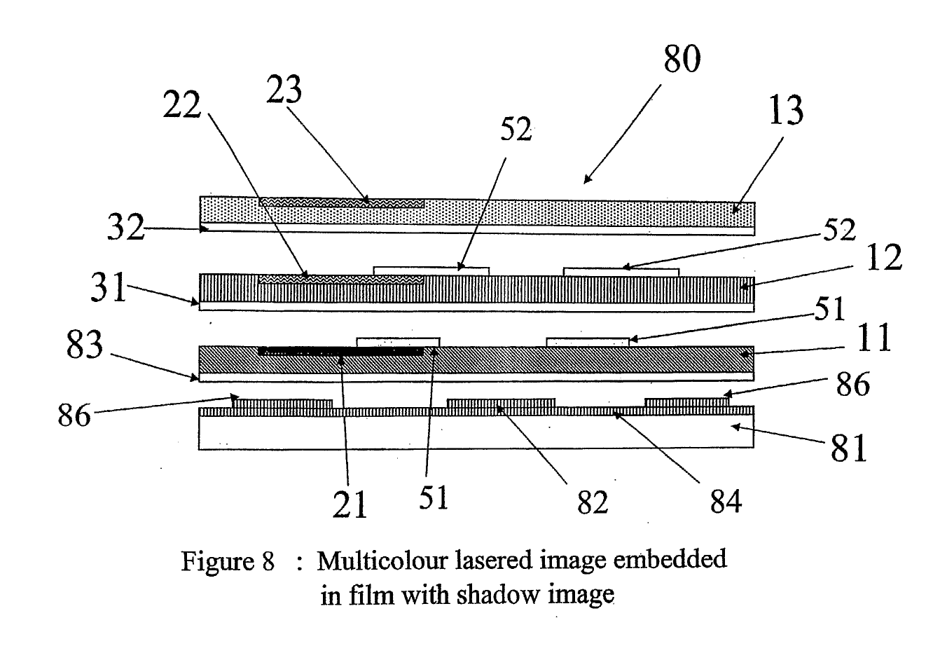

FIG. 8 is a sectional view similar to FIG. 5 of a further modified embodiment;

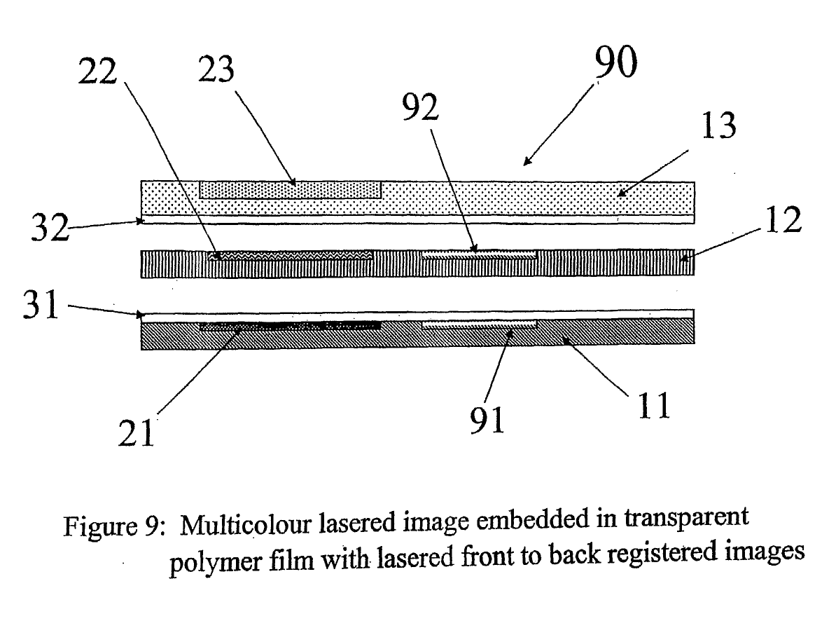

FIG. 9 is a sectional view similar to FIG. 3 of a still further modified embodiment;

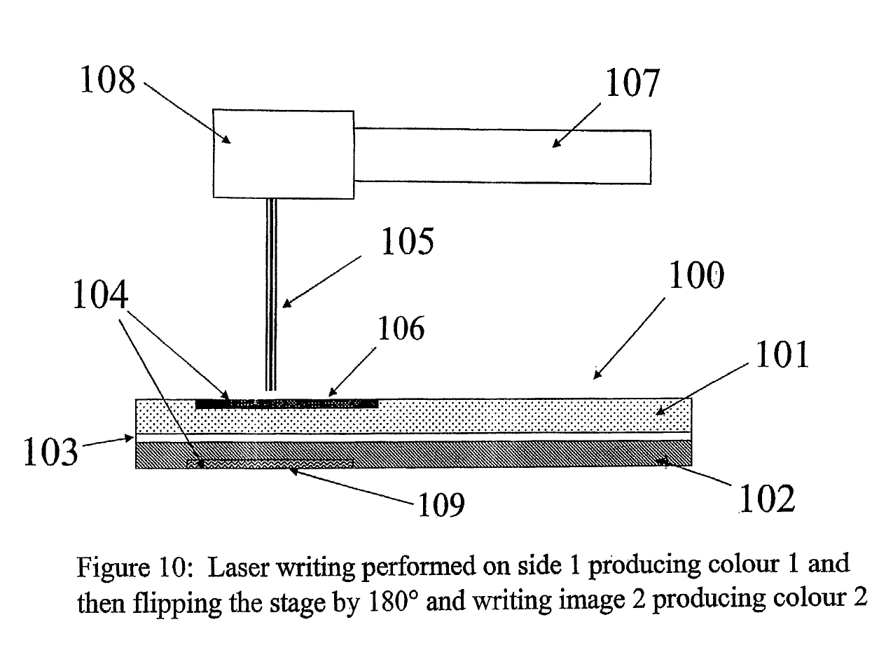

FIG. 10 is a schematic view showing laser writing apparatus for forming a security article according to one method of the invention;

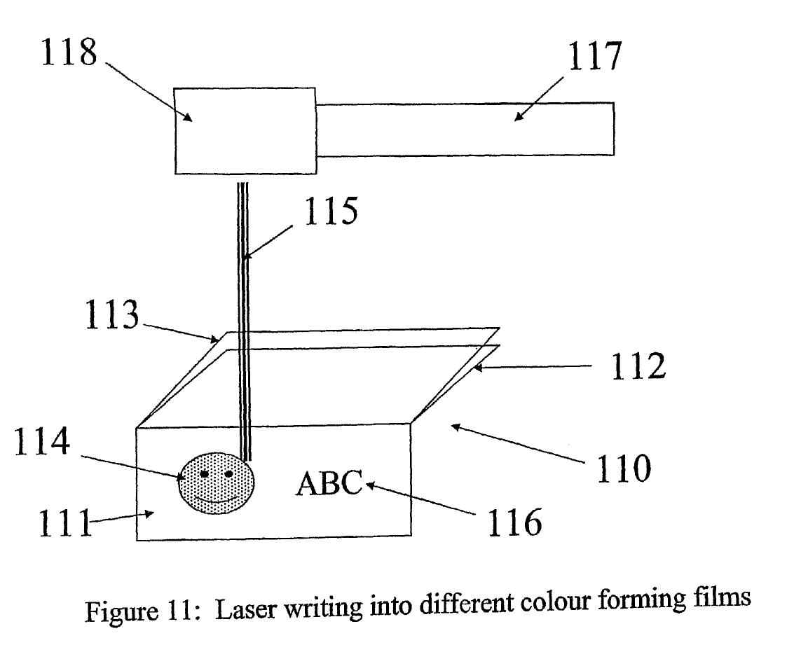

FIG. 11 is a schematic view showing laser writing apparatus for forming a security article in accordance with another method;

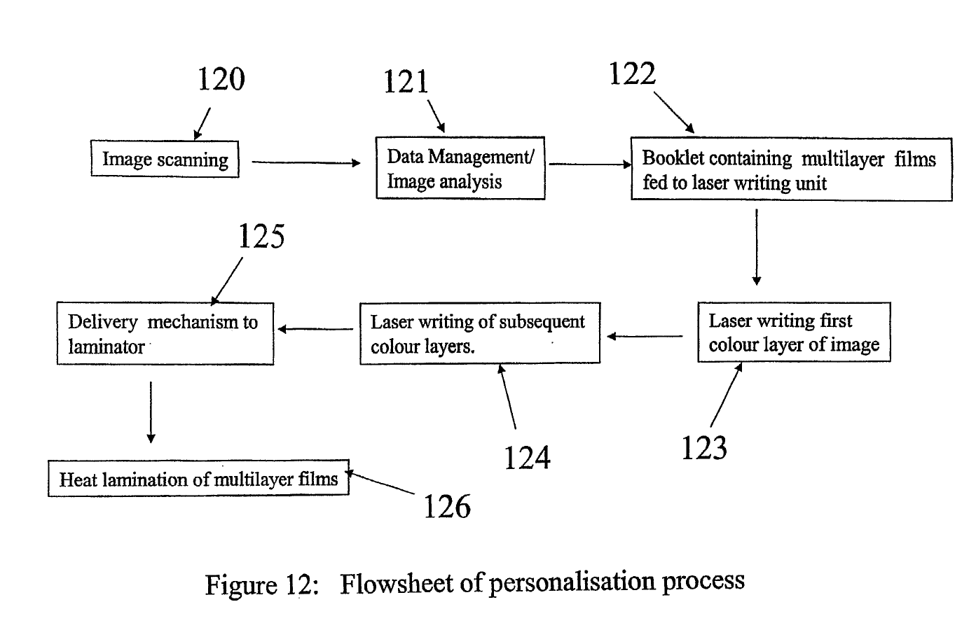

FIG. 12 is a flowchart of a preferred method in accordance with the invention; and

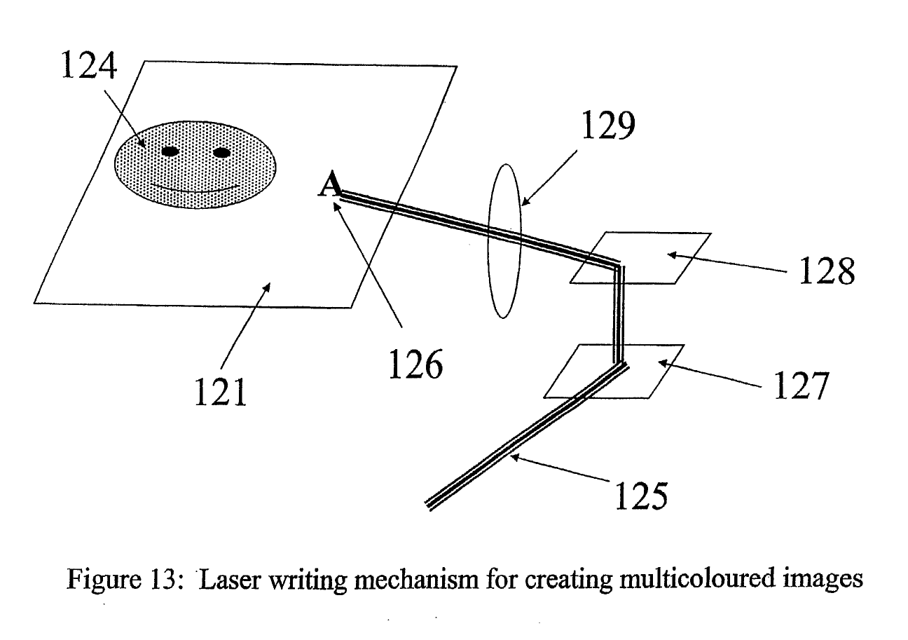

FIG. 13 is a schematic view of alternative laser writing apparatus.

FIG. 1 shows a laminated security article 10 formed from three layers of transparent polymeric material 11, 12, 13 and having a multicoloured image 14 and alphanumeric information 16. Referring to FIG. 2, each of the transparent layers 11, 12, 13 carries at least part of the image 14 formed in a different primary or complementary colour from other layers. Thus the first layer 11 may carry a part of parts of the image 14 formed in a first single colour 21 such as blue or cyan, the second layer 12 may carry a part or parts of the image 14 formed in second, different colour 22, such as green or yellow, and the third layer 13 may carry a part or parts of the image 14 formed in a third, different colour 23, such as red or magenta.

The three transparent layers 11, 12 and 13 are superposed with the parts of the image formed by the different colours 21, 22 and 23 in the layers 11, 12 and 13 superposed one over another so that in the complete laminated security article 10, the different colours 21, 22 and 23 combine to form the multicoloured image 14.

As shown in FIG. 2, the alphanumeric information 16 may be formed by printing ink 26, 27 and 28 applied to the respective layers 11, 12, 13. However, it will be appreciated that the alphanumeric information may be formed in other ways, eg by embossing, and may only be applied to one or two of the transparent layers 11, 12, 13.

The schematic section of FIG. 3 shows a preferred manner of forming the security article of FIG. 1. Each of the parts of the multicoloured image 14 formed in different colours 21, 22, 23 is embedded in its respective transparent polymeric layer 11, 12, 13. This is preferably achieved by incorporating a latent colour forming material in each transparent polymeric layer 11, 12, 13 and irradiating each layer with laser radiation of a particular wavelength to form the required part or parts of the image 14 in the respective colour 21, 22, 23 for each layer 11, 12, 13. A first laminating layer 31 is applied between the first and second transparent layers 11, 12, and a second laminating layer 32 is applied between the second and third transparent layers 12, 13. The laminating layers 31, 32 are preferably formed from a low melting point polymer or heat and/or pressure sensitive adhesive. The transparent layers 11, 12, 13 can then be laminated together by applying heat and/or pressure.

As shown in FIG. 3, the first laminating layer 31 is provided on the upper surface of layer 11 and the second laminating layer 32 is provided on the lower surface of layer 13. It will, however, be appreciated that the laminating layers 31 and 32 may be provided on the lower and upper surfaces of the second transparent layer 12.

FIG. 4 shows a modified embodiment of a security article 40 which is similar to that of FIG. 3 and similar reference numerals have been applied to corresponding parts. The article 40 differs from that of FIG. 1 in that it includes a fourth layer of polymeric material 41 which carries parts 44 of the multicoloured image formed in a dark colour, such as black. The dark parts of the image provide more depth and definition to the multicoloured image formed by the parts of the multicoloured image formed in the different primary or secondary colours 21, 22 and 23 in the other transparent layers 11, 12 and 13.

The fourth polymeric layer 41 is laminated to the first transparent polymeric layer 11 by a third laminating layer 43 provided between the first and fourth polymeric layers 11 and 41. As shown in FIG. 4, the third laminating layer 43 is provided on the lower surface of the first polymeric layer 11, but it could equally be applied on the upper surface of the fourth polymeric layer 41.

The security article 40 also incorporates further information, such as alphanumeric information 46. FIG. 4 shows the alphanumeric information 46 provided on the fourth polymeric layer 41, but it will be appreciated that alphanumeric information may be provided on any or all of the other polymeric layers 11, 12, 13 or 41. The alphanumeric information 46 and the dark parts 44 of the image may be embedded in the polymeric layer 41 by incorporating a latent colour forming material in the polymeric layer 41 which produces a dark colour, such as black, when irradiated with laser radiation of a particular wavelength. Alternatively, the alphanumeric information 46 may be formed on the polymeric layer 46 by printing or other methods.

The fourth polymeric layer 41 may be formed from a transparent polymeric material when it is desired to produce a security article with a multicoloured image that is visible from both sides. Alternatively, the fourth polymeric layer 41 may be formed from a substantially opaque material, preferably white or a light colour. In this case, the opaque fourth layer provides a contrasting background to the multicoloured image which can enhance its appearance. In this case, however, the multicoloured image is only visible in reflection from one side of the security document. In a modified embodiment, the fourth layer 41 may be formed from a transparent polymeric material with one or more opacifying layers applied to its outer surface.

FIG. 5 shows another modified embodiment of a security article 50 which is similar to that of FIG. 3 with corresponding reference numerals applied to corresponding parts. The security article 50 differs from that of FIG. 3 in that it includes additional images 51, 52 printed with optically variable inks on the first and second transparent layers 11, 12. Examples of optically variable inks which may be used include pearl lustre pigments sold by Merck under its Registered Trade Mark IRIODIN and optically variable inks which exhibit a distinct colour change when viewed at different angles, such as pigments sold by SICPA under its registered trade mark OVI.

As shown in FIG. 5, the images 51, 52 printed with optically variable inks are provided at different laterally spaced locations on the first and second transparent layers 11, 12 and may partly overlap with each other and/or with the parts 21, 22 of the multicoloured image embedded in the layers 11 and 12. The images 51, 52 provide further security for the article 50 because, if a person attempts to tamper with the document 50 by delamination, the optically variable images 51, 52, being provided on or adjacent to the laminating layers 31, 32, cohesively rupture, yet the personalised information provided by the multicoloured image formed by the coloured parts 21, 22, 23 embedded in the transparent layers 11, 12, 13 remains present.

FIG. 6 shows a further modified embodiment of a security article 60 similar to FIG. 5 and corresponding reference numerals have been applied to corresponding parts. The security article 60 of FIG. 6 differs from that of FIG. 5 insofar as each of the transparent polymeric substrate layers 11, 12, 13 has a transparent coating of polymeric material 61, 62, 63 in which the parts 21, 22, 23 of the multicoloured image 14 formed by different colours are embedded, rather than in the polymeric substrate layers 11, 12, 13 themselves. The transparent polymeric coatings 61, 62, 63 contain hidden colour forming pigments so that the parts 21, 22, 23 of the multicoloured image may be formed by irradiation of the coatings with laser radiation of appropriate wavelengths.

As shown in FIG. 6, the security article 60 also has a fourth polymeric layer 41 in similar manner to the security article 40. The fourth polymeric layer 41 may be a transparent layer or an opaque layer as described with reference to FIG. 4. FIG. 6 shows the fourth polymeric layer 41 laminated to the third, upper layer 13 of transparent polymeric material by laminating layer 43, rather than being laminated to the first, lower layer 11 as shown in FIG. 4.

The security article 60 also includes optically variable images 51, 52 which may be printed with optically variable inks in similar manner to the security article 50 of FIG. 5. The security article 60 may also include alphanumeric information (not shown) which may be printed on one or more of the layers as described with reference to FIGS. 3 and 4.

FIG. 7 shows yet another modified embodiment of a security document 70 which is similar to that of FIG. 5 and corresponding reference numerals have been applied to corresponding parts. The security document 70 differs from that of FIG. 5 in that the part 22 of the multicoloured image carried by the second layer 12 is embedded within a coating 72 of polymeric material on the second layer 12 rather than in the second layer 12 itself. The parts 21, 23 of the multicoloured image carried by the first and third layers 11 and 13 are embedded within those layers. The parts 22 and 23 of the multicoloured image formed in each layer are preferably formed by irradiation of the layers with laser radiation of an appropriate wavelength to develop colours in latent colour forming pigments contained within the first and third polymeric layers 11 and 13 and within the polymeric coating 72 on the second transparent polymeric layer 12.

FIG. 8 shows a further modified embodiment of a security article 80 which is similar to that of FIG. 5 and corresponding reference numerals have been applied to corresponding parts. The security article 80 differs from that of FIG. 5 in that it includes a fourth layer 81 of transparent polymeric material which carries shadow images 82 of varying opacity. The shadow images 82 may be formed by applying opacifying coatings 84, 86 of varying thickness and/or opacity to different locations on the upper surface of the fourth layer 81. The opacifying coatings may be formed from an opacifying white pigment eg titanium dioxide dispersed in a polymeric binder. A shown in FIG. 8, the shadow images 82 are formed by a first thin coating 84 applied over the entire surface of the fourth layer 81 and a second thin coating 86 applied to different regions of the fourth layer eg by printing. The fourth layer 81 is laminated to the first layer 11 by a laminating layer 83 applied to the lower surface of the first layer 81.

The shadow images 82 provide further security against tampering in that they are embedded within the article 80 and if the article is tampered with, the shadow images 82 or part of the shadow image 82 may rupture upon delamination while the personalised information provided by the multicoloured image remains present.

FIG. 9 shows a still further modified embodiment of a security article 90 which is similar to that of FIG. 3 and corresponding reference numerals have been applied to corresponding parts. The security article 90 differs from that of FIG. 3 in that it includes at least two image portions or partial images 91 and 92 applied to at least two of the transparent polymeric layers 11 and 12. The image portions or partial images 91, 92 together form a front to back registered image when the partial images 91, 92 are superposed one over the other in register. Preferably, at least one of the partial images 91, 92 is embedded within or permanently applied to the transparent polymeric layer or layers 11, 12, eg by etching marking or with a laser. Although both partial images 91, 92 are shown embedded or etched into the respective layers 11, 12 in FIG. 9, in a modified embodiment, one of the partial images 91 or 92 of the front to back registration image may be printed on its respective layer 11 or 12. In this case, if the security article 90 is tampered with, the printed partial images is destroyed on delamination so that a person attempting to fraudulently alter the document has to create a new partial image and place it in exact registration with the other partial image 92 or 91 embedded or laser marked in the other transparent polymeric layer 12 or 11.

Although only two partial images 91, 92 are shown in FIG. 9, it will be appreciated that partial images may be provided in all those transparent layers 11, 12, 13 which also contain the parts 21, 22 and 23 of the multicoloured image. Again, lamination layers 31 and 32 are provided between the transparent layers 11, 12 and 13 to laminate the transparent layers together with the parts 21, 22 and 23 in registration to form the multicoloured image and the partial images 91, 92 in registration to form the front to back registration image.

It will also be appreciated that further variations and modifications may be made to the embodiments of FIGS. 3 to 9. For instance, those embodiments shown with only three polymeric layers 11, 12, 13 may incorporate at least one further polymeric layer, transparent or opaque, as described with reference to FIG. 4. Also, a security article in accordance with the invention may incorporate different combinations of any or all of the additional features of printed information, optically variable images, shadow images and front to back registration images, in addition to multicoloured images formed by the coloured parts 21, 22, 23 in the respective transparent layers 11, 12, 13.

FIG. 10 shows one method of forming a security article in accordance with the invention. In FIG. 10, a security article 100 comprises a first layer 101 of transparent polymeric material containing a first laser sensitive colour forming material and a second layer 102 of transparent polymeric material containing a second laser sensitive colour forming material. The two layers 101 and 102 are laminated together by a lamination layer 103.

A multicoloured image 104 can be formed in the security article 100 by first exposing the first layer 101 to a laser beam 105 of a particular wavelength required to develop the first colour forming material in the first layer 101 to form parts 106 of the multicoloured image in a first colour (eg red or magenta). The laser beam, 105 is generated from a laser source 107 and preferably a beam deflector unit 108 is used to direct the laser beam 105 onto the first layer 101 to write the parts 106 of the multicoloured image in the first colour. Then the security article 100 can be turned over so that the second layer 102 is facing the laser apparatus so that parts 109 of the multicoloured image in the second colour (eg blue or cyan) can be written in the second transparent layer 102.

Although it is possible to form a multicoloured image from only two transparent layers containing parts of the image in two different primary or complementary colours, if a third colour is required, (eg yellow or green), a third transparent polymeric layer containing a third colour forming material can be provided in which parts of the image in the third colours can be written using the laser apparatus. The third transparent layer can be laminated to either side of the security article 100 formed by the first and second transparent layers 101, 102 either before or after the parts of the image are written in the third colour by the laser beam.

As alternatives to a laser marking process which uses the beam deflection technique, a mask technique or a dot matrix technique may be used. For variable data such as personalisation, the beam deflection and dot matrix techniques are most suitable. The main advantages are due to the high degree of flexibility associated with the beam deflection or two rotary mirrors. A change in marking is possible simply by changing the computer program. In this process the marking is performed in similar manner to a plotter, however, with far greater speed. The advantages of laser marking variable data is that it is contact free which results in little or no mechanical wear. It is ink free with no expensive consumables and has no problems with volatile inks. It also has a high marking speed. Up to 6000 markings per min. may be obtained with a pulsed CO₂ laser and up to 3000 mm/sec of markings may be obtained with a Nd:YAG laser. The desired fidelity and resolution of the marked image is a compromise between speed, laser energy and wavelength and the interaction of these with the material. In the case of a 1064 nm Nd: YAG laser the resolution can be in the order of a 10 μm spot size (approx 2500 dots per inch in an image is possible). The principle of colour formation with Merck pigments is based on carbonisation and surface forming between the TiO2 coated mica pigments, the polymer and the laser energy. For lower wavelength lasers such as Nd: YAG laser at 355 nm the image resolution could even be higher. CIBA colour forming additives in the transparent polymeric layers could be used for creating a colour change at such a wavelength. The laser energy strips a proton off the hydrocarbon molecule which reacts with a latent colour former to produce a colour of specific wavelength of light.

Referring to FIGS. 11 and 12 there is illustrated schematically a laser writing apparatus and method for forming a security article 110 in accordance with the invention. The security article 110 in FIG. 11 is in the form of a booklet which has three transparent layers of polymeric material 111, 112 and 113 each forming a page or leaf of the booklet. In the case of a passport, which is required to contain personalised information, eg in the form of a multi-coloured photograph, the transparent layers 111, 112 and 113 may be stitched directly into the booklet before personalisation.

The laser writing apparatus in FIG. 11 is similar to that of FIG. 10 in that it comprises a laser source 117 and a beam deflector unit 118 for directing a laser beam 115 of a particular wavelength onto the layers 111, 112 and 113 of transparent polymeric material, each of which contains a laser sensitive colour forming material in a different colour. For example, the first layer 111 could contain a first latent colour forming pigment which forms a red or magenta colour when exposed to laser radiation of a particular wavelength, the second layer could contain a blue or cyan colour forming pigment and the third layer could contain a green or yellow colour forming pigment.

A preferred method of forming the security article 110 with a personalised multicoloured image is illustrated schematically in the block diagram of FIG. 12. First, the personalised multicoloured image to be provided in the article 110 is scanned (Step 120) at high resolution, eg by any appropriate imaging software package. Next, the image is analysed by data management software (Step 121) to separate the multicoloured image into individual components of primary or complementary colours corresponding to the colours of the colour forming pigments in the layers 111, 112 and 113. The booklet 110 containing the transparent layers of polymeric films 111, 112, 113 is then fed to the laser writing apparatus 117, 118 (Step 122) and laser writing software is used to control the apparatus 117, 118 to write parts of the multicoloured image 114 in the first colour in the transparent layer 111 (Step 123).

After the parts of the image 114 have been written in the first colour, the next page or leaf of the booklet formed by the second layer 112 is turned over and placed in the laser writing apparatus, so that the laser beam 115 can be used to write parts of the image 114 in the second colour of the colour forming material in the second layer 112 (Step 124). A laser blocking sheet (not shown) may be placed between the first and second layers 111 and 112 to prevent laser strike through to the first layer 111 when parts of the image 114 are being written in the second layer 112.

The page or leaf of the booklet formed by the third transparent layer 113 is then turned over and placed in the laser writing apparatus and Step 124 is repeated to write parts of the image 114 in the third colour of the colour forming material in the third layer 113. Again, a laser blocking sheet may be placed between the second and third layers 112, 113 to prevent laser strike through to the second layer when parts of the image are being written in the third layer.

The security article 110 may include an optional fourth layer (not shown) containing a laser sensitive colour forming pigment which produces a dark colour, eg black, when exposed to laser radiation of a particular wavelength. Again, step 124 can be repeated so that the laser writing apparatus writes parts of the image in the dark colour to provide more depth and definition to the multicoloured image.

Each of the parts of the multicoloured image 114 in the different colours of the different layers may be formed in dots, lines or crosses, or a combination thereof. The size and frequency of the structural pattern may be varied. In some cases interference effects, such as moire fringes, may be created, although in other cases interference effects should be avoided. The multicoloured image may be constructed of a specific pattern or screen, such as a stochastic screen. Such a screen could be viewed under magnification (eg ×10) and act as a secondary level security feature. Also, the colour forming materials in the transparent layers can be selected so that additive colours are used to produce other colours in the multicoloured image. For example, layers containing green and blue colours could be used to create cyan lines and dots.

One or more of the transparent layers 111, 112, 113 may also include alphanumeric information 116 which may be applied to the layer or layers by printing and/or by laser writing. Other security features may be applied to the layers 111, 112, 113 such as shadow images, images formed with optically variable inks and front to back registered images as described with reference to FIGS. 5 to 9.

When all the parts of the multicoloured image have been written in the different colours in the different layers 111, 112, 113, the booklet 110 formed by the layers is then passed by a delivery mechanism to laminating apparatus (Step 125) where the transparent layers 111, 112, 113 containing the parts of the multicoloured image in the different colours are laminated together (Step 126) eg by applying heat and/or pressure, to form the laminated security article which may be a passport data page or an identity card. For this purpose, laminating layers of low melting point polymers may be applied between the transparent layers 111, 112, 113 as described with reference to FIGS. 3 to 9. The laminating temperature is selected such that the temperature is greater than the melting point of the laminating polymer but lower than the melting point of the polymeric material of the transparent layers 111, 112, 113.

FIG. 13 shows an alternative laser apparatus for creating multicoloured images in a security article. Instead of the beam deflector 118 of FIG. 11, the laser beam 125 is reflected off two rotary scanning mirrors 127, 128 and focussed by a lens 129 onto a transparent polymeric layer 121 containing a first laser sensitive colour forming material to write parts of a multicoloured image 124 in the layer 121. The process is then repeated for at least one other transparent layer containing a different laser sensitive colour forming material, in similar manner to that described with reference to FIGS. 12 and 13. The laser beam 125 may also be used to write alphanumeric information 126 in one or more of the transparent layers 121 as shown in FIG. 13.

From the above description it will be apparent that the present invention provides various forms of security articles with tamper evident multicoloured images and methods for manufacturing such security articles. The tamper evident lasered images cannot be removed without an indication of manipulation. The images cannot be leached out with solvents or other chemicals and are resistant to abrasion. Most personalised documents are based on an opaque substrate where the image is only viewable from side. The multicoloured images in security articles according to the first aspect of the invention are viewable from both sides which makes it easier to identify any tampering. Even if the multilayer security article is delaminated the images are still embedded in the core polymer. Furthermore, the laser embedded images can be combined with other printed security features.

It will be appreciated that various modifications and alterations may be made to the preferred embodiments described above without departing from the scope and spirit of the invention.

1. A security article having a multicoloured image and which comprises:
a first layer of transparent polymeric material carrying parts of an image formed in a first colour;
at least one other layer of transparent polymeric material carrying parts of said image formed in at least one different colour;
wherein the layers are laminated together with the parts of the image formed in the first and different colours superposed one over another, so that the colours combine to form a multicoloured image in the laminated security article, the multicoloured image being viewable from both sides of the security article.

2. A security article according to claim 1 wherein the multicoloured image is formed by first and second superposed parts of the image in different colours in first and second layers.

3. A security article according to claim 2 further comprising a third layer of transparent polymeric material carrying parts of an image formed in a third colour.

4. A security article according to claim 1 wherein the colours of the image formed in the layers are primary or complementary colours.

5. A security article according to claim 1 further comprising an additional layer of transparent polymeric material carrying parts of the image formed in a dark colour to provide more depth and definition to the multicoloured image.

6. A security article according to claim 5 wherein the dark colour is black.

7. A security article according to claim 1 wherein the parts of the image formed in the layers are indelible.

8. A security article according to claim 7 wherein the parts of the image formed by the different colours are formed in the different layers by laser marking.

9. A security article according to claim 7 wherein at least one of the layers comprises a transparent polymeric film or substrate in which a respective part of the image is embedded.

10. A security article according to claim 7 wherein at least one of the layers comprises a transparent polymeric substrate having a transparent polymeric film or coating on at least one surface in which a respective part of the image in colour is embedded.

11. A security article according to claim 8 wherein the parts of the image formed in different colours in the respective layers are embedded within the layers by using layers of transparent polymeric material each containing a respective latent colour forming pigment which is developed by exposure to laser radiation.

12. A security article according to claim 1 wherein at least one of the layers includes alphanumeric information.

13. A security article according to claim 1 further including any one or more of the following:
shadow images; or
images printed with optically variable inks; or
front to back registration images.

14. A security article according to claim 1 wherein the security article is adapted to be secured to another article.

15. A security article according to claim 1 wherein the multicoloured image is a photograph of the bearer of the article.

16. A security article according to claim 15 wherein the article forms a part of a passport or other identification document.

17. A passport incorporating a security article according to claim 15 wherein the article forms at least part of a page of the passport such that the photograph of the bearer of the passport is viewable from both sides of the page.

18. A passport according to claim 17 wherein the passport is a booklet which includes at least one opaque page next to the page incorporating the photograph.

19. A method of manufacturing a security article having a multicoloured image, wherein the method comprises:
providing a first layer of transparent polymeric material;
providing at least one other layer of transparent polymeric material;
forming parts of an image in a first colour in or on the first layer;
forming parts of said image in at least one different colour in or on said at least one other layer; and
laminating the layers together to form a laminated security article;
wherein, in the laminated security article the parts of the image formed in the first and different colours are superposed one over another so that the colours combine to form a multicoloured image which is viewable from both sides of the laminated security article.

20. A method according to claim 19 wherein the multicoloured image is formed by first and second superposed parts of the image in different colours in first and second layers.

21. A method according to claim 20 wherein the first and second layers are laminated before the parts of the image are formed in the different colours in the respective layers.

22. A method according to claim 20 wherein the first and second layers are laminated after the parts of the image are formed in the different colours in the respective layers.

23. A method according to claim 19 the method further comprising the steps of:
providing a third layer of transparent polymeric material; and
forming parts of the image in a third colour in or on the third layer.

24. A method according to claim 19 wherein the colours of the image formed in the different layers are primary or complementary colours.

25. A method according to claim 19 the method further comprising the steps of:
providing a further layer of transparent polymeric material; and
forming parts of an image in a dark colour in or on the further layer whereby the dark colour provides more depth and definition to the multicoloured image.

26. A method according to claim 25 wherein the dark colour is black.

27. A method according to claim 19 wherein the parts of the image formed in the different colours are applied to the different layers by a laser marking process.

28. A method according to claim 27 whereby the image to be formed in the laminated security article is scanned by software into a digital image and separated into individual primary or complementary colours, before the laser marking process.

29. A method according to claim 27 whereby the laser marking process includes the steps of:
applying the parts of the image formed in the first colour to the first transparent layer;
applying the parts of the image formed in the second colour to the second transparent layer; and optionally
applying the parts of the image formed in other different colours to third and any subsequent layers.

30. A method according to claim 19 whereby the different parts of the image in different colours are embedded within the respective layers of transparent polymeric material.

31. A tamper evident security article having a multicoloured image and which comprises:
a first layer of transparent polymeric material containing parts of an image formed in a first colour embedded within said first layer;
at least one other layer of transparent polymeric material containing parts of said image formed in at least one different colour embedded within said at least one other layer;
wherein the layers are laminated together with the parts of the image formed in the first and different colours superposed one over another, whereby the colours combine to form a multicoloured image in the laminated security article.

32. A tamper evident security article according to claim 31 wherein at least one of the layers comprises a transparent polymeric film or substrate in which a respective part of the image is embedded.

33. A tamper evident security article according claim 31 wherein at least one of the layers comprises a transparent polymeric substrate having a transparent polymeric film or coating on at least one surface in which a respective part of the image in colour is embedded.

34. A tamper evident security article according to claim 31 wherein the parts of the image formed in different colours in the respective layers are embedded within the layers by using layers of transparent polymeric material each containing a respective latent colour forming pigment which forms a colour marking when exposed to laser radiation.

35. A tamper evident security article according to claim 34 wherein the thickness of each layer of the polymeric material falls substantially within the range from about 20 microns to about 200 microns.

36. A tamper evident security article according to claim 34 wherein a thin layer of a low melting point polymer is co-extruded onto one or both sides of a polymer base film to form at least one of the layers in which a colour forming material is provided.

37. A tamper evident security article according to claim 36 wherein the colour forming material is provided in the polymer base film.

38. A tamper evident security article according to claim 36 wherein the colour forming material is provided in the co-extruded layer.

39. A tamper evident security article according to claim 36 wherein the thin co-extruded layer has a thickness falling substantially within the range from about 2 microns to about 50 microns.

40. A tamper evident security article according to claim 36 wherein the co-extruded layer is formed from any one of metallocene polyethylene, random co-polymers or ter-polymers of ethylene, butylene or propylene.

41. A tamper evident security article according to claim 34 wherein the latent colour forming pigments are present in the layers of transparent polymeric material in a concentration falling substantially within the range from about 0.2% to about 0.5% by weight of the polymeric material.

42. A tamper evident security article according to claim 31 wherein the article is adapted for attachment to another article.

43. A tamper evident security article according to claim 31 further including an opaque layer on one side of the transparent layers containing parts of the image in different colours, so that the multicoloured image in the laminated security article is only visible in reflection from one side of the article.

44. A tamper evident security article according to claim 31 wherein at least one of the layers includes printed information.

45. A tamper evident security article according to claim 31 further including one or more of:
printed shadow images; or
images printed with optically variable inks; or
front to back registration images.

46. A method of manufacturing a tamper evident security article having a multicoloured image, wherein the method comprises:
providing a first layer of transparent polymeric material containing a first latent colour forming material;
providing at least one other layer of transparent polymeric material containing a different latent colour forming material;
forming parts of an image in a first colour by exposing the at least one other layer to laser radiation to develop the latent colour forming material in the first layer;
forming parts of the image in a different colour by exposing said at least one other layer to laser radiation to develop the different latent colour forming material in said at least one other layer; and
laminating the layers together with the parts of the image formed in the first and different colours superposed one over another, whereby the colours combine to form the multicoloured image in the laminated security document.

47. A method according to claim 42 wherein the laser radiation causes colour marking by development of the latent colour forming materials without causing melting or abrasion of the polymeric materials.

48. A method according to claim 46 wherein the layers of polymeric material containing the latent colour forming pigments are produced by premixing a batch of polymer which is blended with the respective latent colour forming material.

49. A method according to claim 46 wherein the laser radiation is provided by one of the following:
a beam deflection technique;
a vector process;
a mask technique; or
a dot matrix technique.

50. A method according to claim 46 wherein a laminating layer is applied between adjacent layers of transparent polymeric material containing the colour forming material.

51. A method according to claim 50 wherein the laminating layer is formed from a low melting point polymer or a heat and/or pressure sensitive adhesive and heat and/or pressure is used to laminate the layers of polymeric material together.

52. A method according to claim 46 wherein the colours formed by the latent colour forming materials in the first and other layers are primary or complementary colours.

53. A method according to claim 52 further including the steps of:
providing a further layer of transparent polymeric material containing a dark colour forming material;
forming parts of the image in the dark colour by exposing said further layer to laser radiation; and
laminating said further layer to the other layers with the parts of the image formed in the dark colour superimposed over the parts of the image formed in the different colours to provide more depth and definition to the multicoloured image.

54. A method according to claim 52 wherein the image to be formed in the tamper evident security article is scanned by software into a digital image and separated into individual primary or secondary colour components corresponding to the colour forming materials in the layers, and laser writing software uses the separated colour components to develop the colour forming materials in the respective layers.

55. A method according to claim 46 further including the step of applying alphanumeric information to at least one of said layers.

56. A method according to claim 46 further including the step of providing at least one security feature on at least one of the layers, the security feature being destroyed or damaged when the security article is delaminated.

57. A method according to claim 56 wherein the at least one security feature comprises any one or more of the following:
a shadow image;
an image printed with optically variable inks; and
a front to back registration image.
